(19) United States
(12) Patent Application Publication
(10) Pub. No.: US 2006/0159587 A1
(43) Pub. Date: Jul. 20, 2006

(54) Automated clinical analyzer with dual level storage and access

(75) Inventors: Harold F. Fechtner, Yorba Linda, CA (US); Jack D. McNeal, Long Beach, CA (US)

Correspondence Address: MAGINOT, MOORE & BECK, LLP;CHASE TOWER, 111 MONUMENT CIRCLE, SUITE 3250, INDIANAPOLIS, IN, 46204-5115, US

(73) Assignee: Beckman Coulter, Inc.

(21) Appl. No.: 11/038,853

(22) Filed: Jan. 19, 2005

(51) Int. Cl. G01N 35/00

(52) U.S. Cl. 422/64

(57) ABSTRACT

An automated clinical analyzer comprises an upper carousel operable to rotate about a central axis and a lower carousel operable to rotate about the same central axis. The upper carousel includes a first plurality of seats operable to receive a first plurality of reagent cartridges. The lower carousel includes a second plurality of seats operable to receive a second plurality of reagent cartridges. The analyzer further comprises a reagent probe assembly including a probe tip. The reagent probe assembly is operable to move the probe tip between the upper carousel and the lower carousel and extract liquid reagents from the first plurality of reagent cartridges and the second plurality of reagent cartridges. The upper carousel includes an opening that allows the probe to extend through the opening and reach cartridges located on the lower carousel.

### BACKGROUND

This invention generally relates to the field of automated clinical chemical analyzers, and specifically to high throughput automated chemical analyzers having reagent carousels.

A number of special purpose analyzers are available for the measurement of various analytes in human body fluid samples. In the past, such analyzers were often adapted to test for a single analyte in a patient sample and may have required extensive operator actions to perform an analysis. For example, the operator might be required to perform manual pipetting of patient samples and reagents into a test chamber or cuvette, manual timing of the reaction, and the manual reading of an arbitrary value from the analyzer that is then compared to previously generated calibration values to obtain a final result. As is readily apparent, largely manually operated analyzers are not suitable for either a large number of patient sample analyses or to performing an analysis in a limited amount of time.

In order to meet the increasing demand for the routine testing of a growing number of analytes as well as for the reduction in overall testing costs and the skill required of the technician/operator, many analyzers are now partially or fully automated. A typical automated analyzer can analyze a single fluid sample for a plurality of analytes with little or no intervention on the part of an operator.

The number of different analytes or chemistries that an automated clinical analyzer can analyze is often termed the “menu” of chemistries available on the analyzer. Large scale, highly complex analyzers useful in large hospitals and clinical laboratories have been developed which have both a large menu of tests which the instrument can perform and a high throughput. An automated analyzer may be designed, for example, to analyze a limited menu of basic chemistries that represent the bulk of the work load in a clinical chemistry laboratory, such as glucose, creatinine, sodium, potassium and the like. On the other hand, other analyzers may offer a much larger menu, sometimes ranging up to 50 or 60 different chemistries. Many of such chemistries may represent relatively low volume chemistries, that is, ones that are required on an infrequent basis as compared to the basic chemistries mentioned above.

Each chemistry run on an analyzer generally requires its own unique reagent or combination of reagents. Although it would be desirable to maintain all of the reagents on the analyzer for each of the chemistries on the menu, most large menu analyzers do not have the storage capacity to do so. Instead, reagents for a subset of the menu are stored on the analyzer at one time. When an analysis is to be run that requires reagents that are not presently stored on board the analyzer, the reagents must be placed onto the analyzer before the analysis is run. If the reagent storage area on analyzer is already full, then reagents for a chemistry not in use are removed and the reagents for the new chemistry are installed in their place. With such an approach, it is desirable that the analyzer maintain as many reagents on board as possible and, further, that reagents be easily removed and replaced so that analyzer down time and operator time can both be minimized.

It is known in the art to use reagent cartridges on automated clinical analyzers to increase the ease with which reagents are handled and decrease the time required to reconfigure the chemistries on board the analyzer. Such cartridges may contain all of the various reagents required for a particular chemistry and may be configured to fit onto a reagent storage rack or wheel within the analyzer. These storage racks or wheels are typically moveable such that the reagents may be automatically moved into and out of a loading position. Moveable reagent storage racks, including those in the form of rotatable wheels, are referred to herein as reagent “carousels”.

The limited storage capacity for reagent cartridges in automated clinical analyzers is problematic, as laboratory technicians and other users of the analyzers can spend significant amounts of time loading and unloading reagent cartridges from the reagent carousels. This loading time results in lower volumes of chemistry runs because of the downtime to change or add more reagents. Thus, it would be desirable to provide an automated clinical analyzer with increased reagent storage space, allowing the downtime for the automated clinical analyzer to be significantly reduced. Although increased storage space could be achieved by providing a much larger analyzer, substantial increases in the size of the analyzer are unrealistic from a cost and space perspective. Accordingly, it would be advantageous to provide and automated clinical analyzer that significantly increases the reagent storage space without substantially increasing the size or cost of the automated clinical analyzer.

### SUMMARY OF THE INVENTION

An automated clinical analyzer comprises a storage rack including a first plurality of reagent cartridge seats and a second plurality of reagent cartridge seats. The first plurality of reagent cartridge seats are positioned higher than the second plurality of reagent cartridge seats. Accordingly, the automated clinical analyzer provides for multiple levels of reagent storage in the vertical direction.

In one embodiment, the automated clinical analyzer comprises an upper reagent carousel operable to rotate about a central axis and a lower reagent carousel operable to rotate about the central axis. The upper carousel includes the first plurality of reagent cartridge seats and is operable to receive a first plurality of reagent cartridges. The lower carousel includes a second plurality of reagent cartridge seats and is operable to receive a second plurality of reagent cartridges. The analyzer further comprises a reagent probe assembly including a probe tip. The reagent probe assembly is operable to move the probe tip between the upper carousel and the lower carousel and extract liquid reagents from the first plurality of reagent cartridges and the second plurality of reagent cartridges.

The upper carousel includes an opening formed by one of the slots that remains free of a reagent cartridge. The opening in the upper carousel allows the probe to extend through the opening and reach cartridges located on the lower carousel.

A dual carousel drive is provided for rotating the upper carousel and the lower carousel. The dual carousel drive includes a first shaft connected to the lower carousel and a second shaft connected to the upper carousel. The first shaft is hollow and the second shaft is at least partially retained within the first shaft and is rotatable with respect to the first shaft. A first gear hub assembly is connected to the first shaft. The first gear hub assembly is connected to a first electric motor through a first drive train. The first electric motor is operable to engage the first drive train, thereby rotating the first gear hub assembly and first shaft. Rotation of the first shaft results in rotation of the lower carousel. Likewise, the second shaft is connected to a second gear hub assembly, second drive train and second electric motor. The second electric motor is operable to drive the second drive train, which rotates the second gear hub and second shaft. Rotation of the second shaft results in rotation of the upper carousel.

The upper carousel and lower carousel are retained within a housing, and an opening is formed in the housing providing access to the upper and lower carousels. The opening in the housing defines a first loading door and a second loading door. The first loading door is designed and dimensioned to allow a reagent cartridge to pass through the first loading door and into one of the plurality of seats of the first reagent carousel. Likewise, the second loading door is designed and dimensioned to allow a reagent cartridge to pass through the second loading door and into one of the plurality of seats of the second reagent carousel. At least one bar code reader is mounted on the housing near the first loading door and the second loading door. The at least one bar code reader is operable to read a bar code positioned on a reagent cartridge before it passes through the first loading door or the second loading door.

Use of the automated clinical analyzer embodies a method of accessing reagents stored in reagent cartridges in a clinical analyzer. One embodiment of the method comprises loading a first plurality of reagent cartridges onto a first reagent carousel and a second plurality of reagent cartridges onto a second reagent carousel. Next, a reagent probe is moved to a reagent extraction site and the probe extracts a reagent from one of the first plurality of reagent cartridges. After this, the reagent probe is moved away from the reagent extraction site and the extracted reagent is dispensed by the probe. Then, the reagent probe is moved back to the reagent extraction site where the probe is used to extract another reagent from one of the second plurality of reagent cartridges.

### BRIEF DESCRIPTION OF DRAWINGS

FIG. 1 is a schematic plan view of an automated clinical analyzer with dual level storage and access;

FIG. 2 is a front view of the automated clinical analyzer of FIG. 1 showing a closed canopy;

FIG. 3 is a front view of the automated clinical analyzer of FIG. 1 showing an open canopy;

FIG. 4A is a perspective view of a sample container rack useful in association with the automated clinical analyzer of FIG. 1;

FIG. 4B is a perspective view of a reaction cuvette useful in association with the automated clinical analyzer of FIG. 1;

FIG. 4C is a perspective view of a reagent cartridge useful in association with the automated clinical analyzer of FIG. 1;

FIG. 5A is a perspective view of a sample probe arm assembly of the automated clinical analyzer of FIG. 1;

FIG. 5B is a perspective view of a reagent probe arm assembly of the automated clinical analyzer of FIG. 1;

FIG. 6A is a top plan view of a first reagent carousel of the automated clinical analyzer of FIG. 1;

FIG. 6B is a side elevational view of the first reagent carousel of FIG. 6A from line B-B;

FIG. 6C is a cross-sectional view of the first reagent carousel through line C-C of FIG. 6A;

FIG. 6D is a perspective view of a first and second reagent carousel of the automated clinical analyzer of FIG. 1 loaded with reagent cartridges;

FIGS. 7A-7E are perspective progressive assembly views of a dual drive mechanism for the reagent carousels of the automated clinical analyzer of FIG. 1;

FIG. 8A is a front perspective view of a reagent cartridge loading station of the automated clinical analyzer of FIG. 1;

FIG. 8B is a rear perspective view of the reagent cartridge loading station of FIG. 10A;

FIG. 8C is a front perspective view of the automated clinical analyzer of FIG. 1 showing the reagent loading station;

FIG. 9 is a perspective view of a crane assembly of the automated clinical analyzer of FIG. 1;

FIG. 10A shows an alternative embodiment of the automated clinical analyzer of FIG. 1 wherein a cartridge lift is used to move reagent cartridges between the first carousel and the second carousel; and

FIG. 10B shows another alternative embodiment of the automated clinical analyzer of FIG. 1 wherein a seat lift is used to elevate or lower reagent cartridges into position for access by the reagent probe.

### DESCRIPTION OF THE BEST MODE OF THE INVENTION

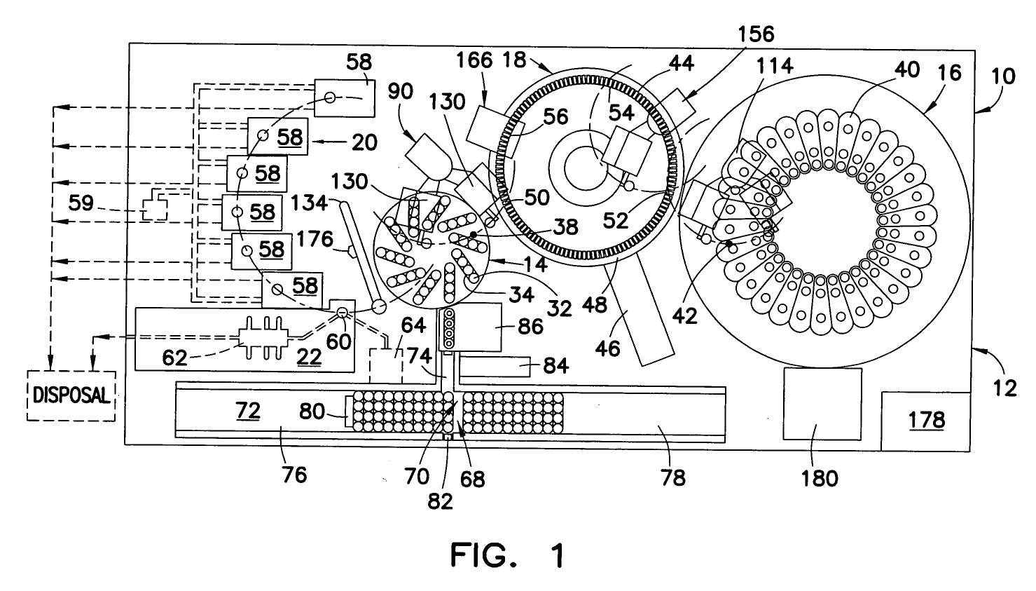

FIGS. 1-3 show an automated clinical analyzer machine 10 comprising a body 12, a sample station 14, a reagent station 16, a random access analyzing station 18, a reaction cup analyzing station 20 and an ion selective electrode analyzing station 22.

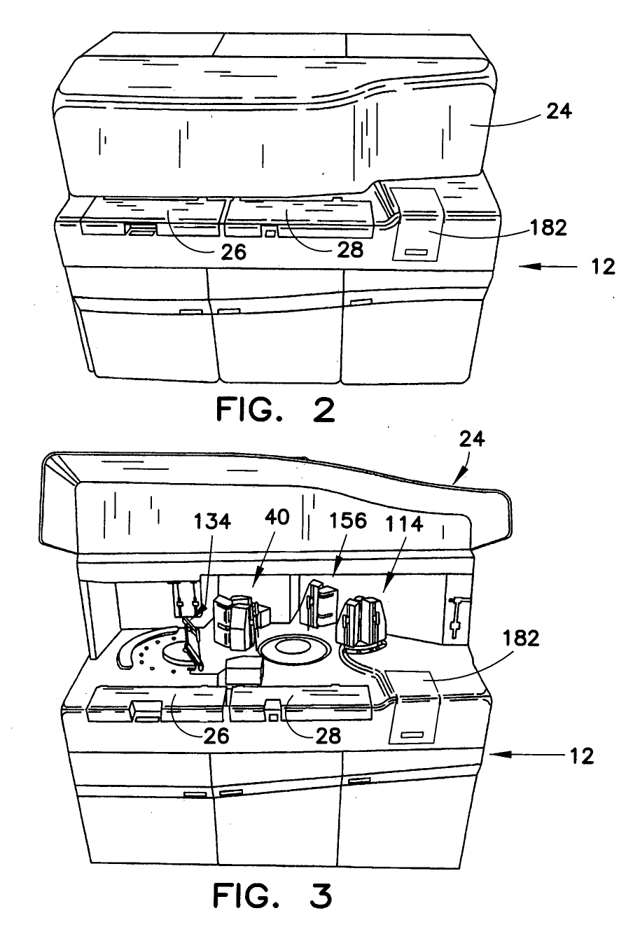

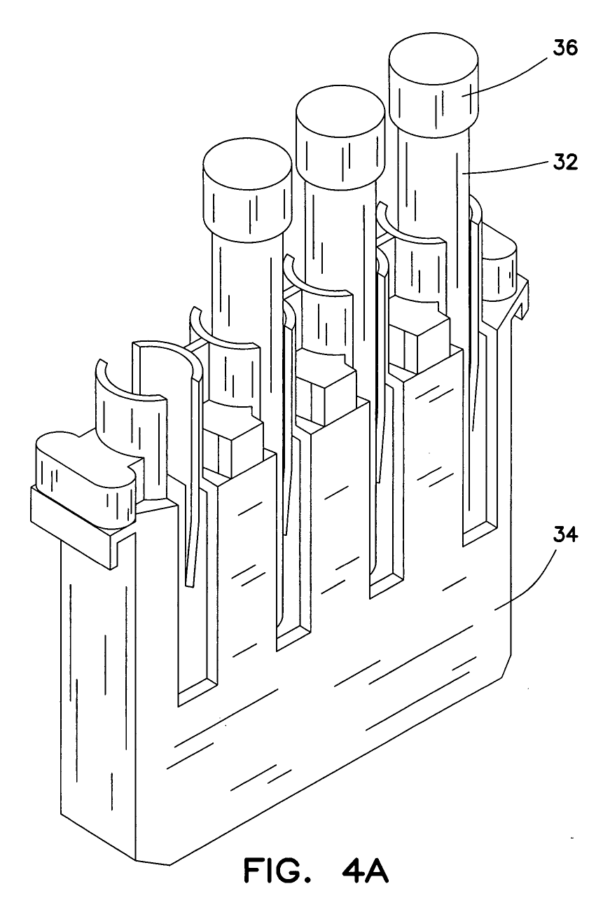

The body 12 is typically a cabinet providing a housing for the various operative components. The body 12 is typically made from a lightweight metal such as a lightweight sheet steel. The embodiment shown in FIGS. 2 and 3 includes a hinged primary canopy 24. FIG. 3 shows the analyzing machine 10 with the primary canopy 24 closed. FIG. 2 shows the machine 10 with the primary canopy 24 open.

FIGS. 2 and 3 also illustrate how the automated clinical analyzer 10 can have an on-load tray cover 26, an off-load tray cover 28, and a reagent loading station cover 182. In addition, the automated clinical analyzer may include one or more operator area covers 30 covering the sample station 14, the reagent station 16, the random access analyzing station 18, the reaction cup analyzing station 20 and/or the ion selective electrode analyzing station 22. As shown in FIGS. 2 and 3, the body 12 of the automated clinical analyzer machine is provided in a horizontal operating orientation. The horizontal operating orientation describes the orientation of the body 12 when a particular plane defined by the body 12 of the clinical analyzer 10 is in a substantially horizontal position such that the clinical analyzer 10 is properly oriented for operation. This horizontal plane may be a plane defined by an actual planar surface of the body or by an imaginary planar surface (e.g., a plane rotated by a certain amount from another surface). In the disclosed embodiment, the one or more operator area covers 30 on the body 12 provide a planar surface that is substantially horizontal in the horizontal operating orientation.

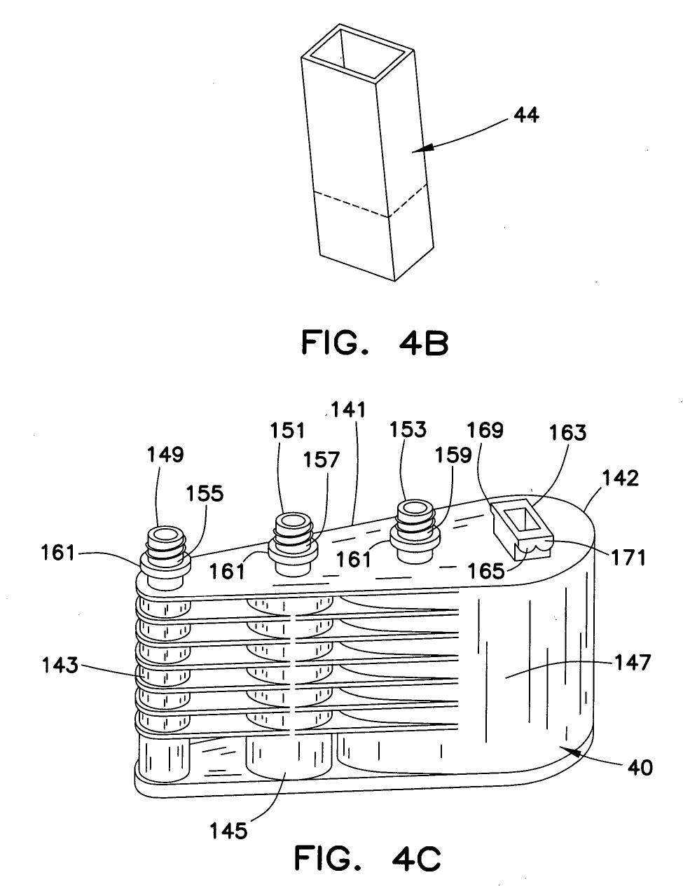

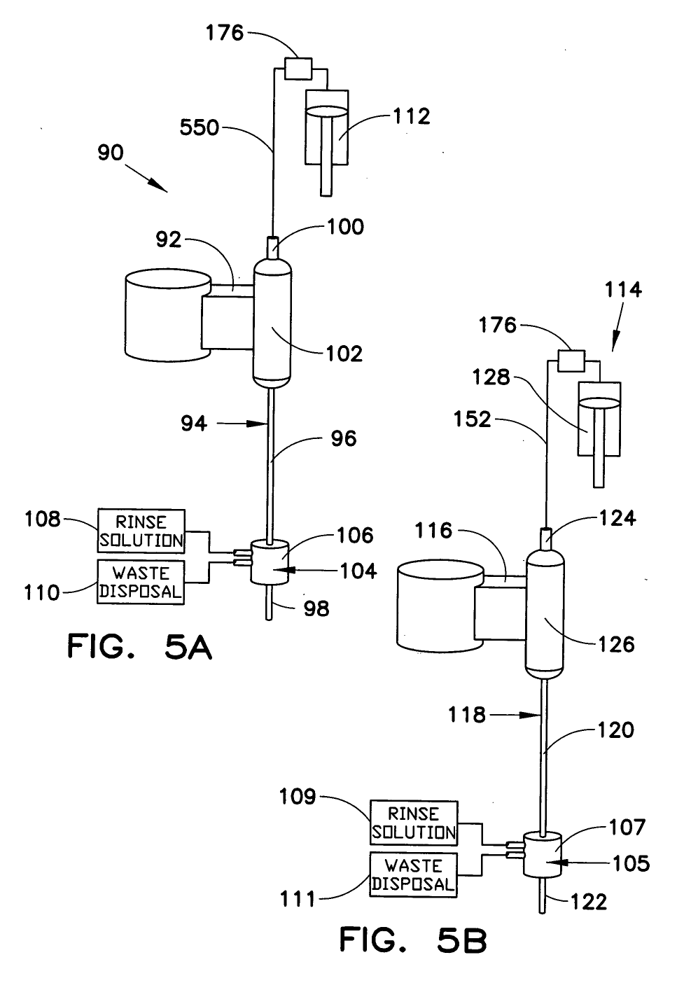

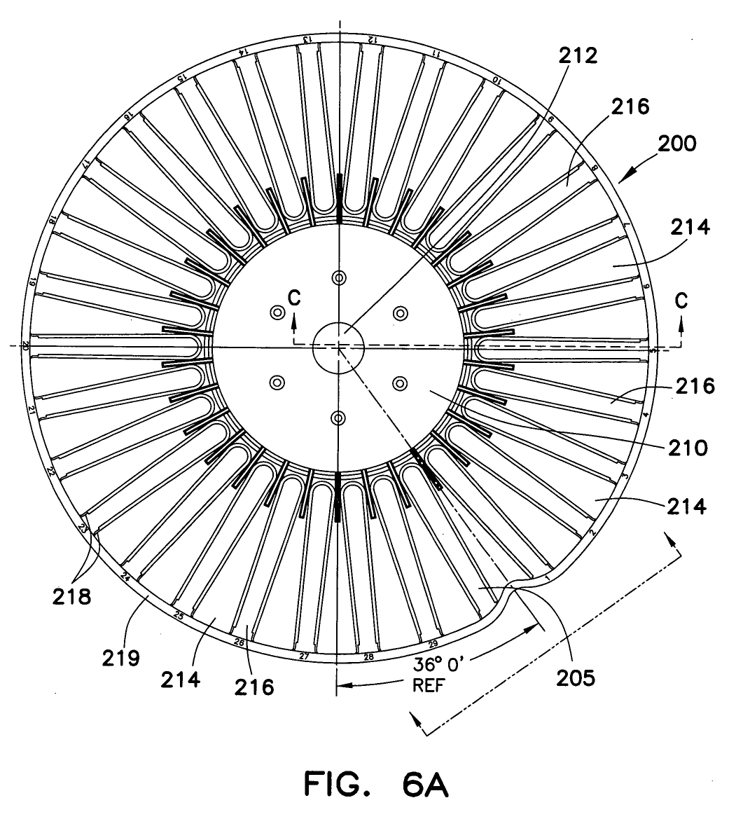

Returning to FIG. 1, the sample station 14 is sized and dimensioned to retain a plurality of sample containers 32. In the embodiment shown in FIGS. 1-3, the sample station 14 is a revolving circular carousel capable of retaining 40 sample containers 32 disposed in ten sample container racks 34. In one embodiment, each sample container 32 is a generally upright container having a container cap 36 of thin rubber or like material. A sample container rack 34 containing four sample containers 32 is shown in FIG. 4A. The sample station 14 is moveable by a rotating motor (not shown) such that each sample container 32 can be alternatively positioned under and moved away from at least one sample extraction site 38.

The reagent station 16 is sized and dimensioned to retain a plurality of reagent containers 40 known as reagent “cartridges”. An exemplary reagent cartridge 40 is shown in FIG. 4C. Each reagent cartridge 40 comprises a body 141 formed to define three reagent storage compartments 143, 145 and 147, each adapted to receive and hold reagents for use in a clinical assay. The body includes openings 149, 151, and 153 formed through the top of the body for access to the storage compartments. Cylindrical necks 155, 157 and 159 surround the respective openings 149, 151 and 153. Each of the necks 155, 157 and 159 also include annular collars 161. The collars 161 together define a plane that is parallel to the top of the body. A detent member 163 is formed on the top of the body 141. The detent member 163 includes flanges 169 and 171 which project outwardly from the detent member in the same plane as the annular collars 161. Teeth 165 are included on the flanges and project slightly downward. The top and bottom of the reagent cartridge are outlined by substantially the same perimeter, and this perimeter defines a reagent footprint 142. A preferred design for a reagent container is further described in detail in U.S. Pat. No. 5,075,082, which is incorporated herein by reference in its entirety.

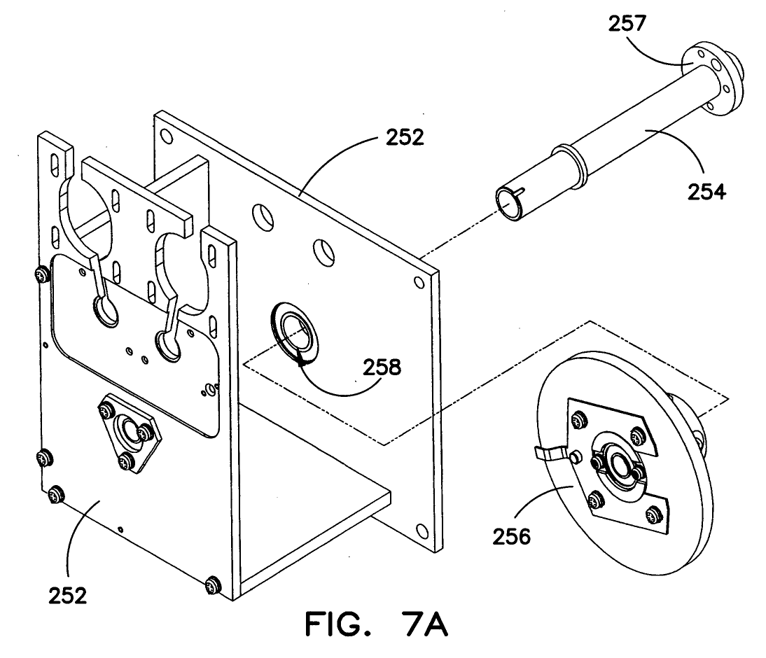

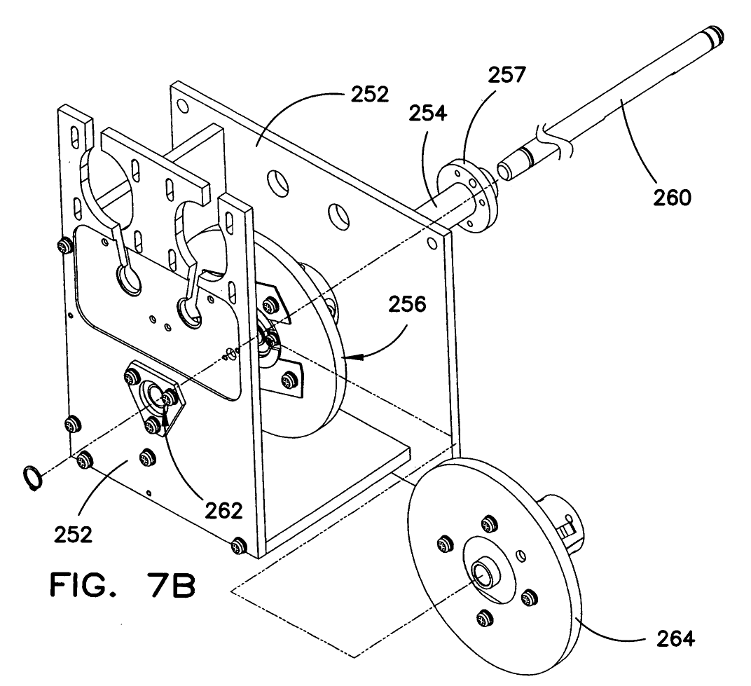

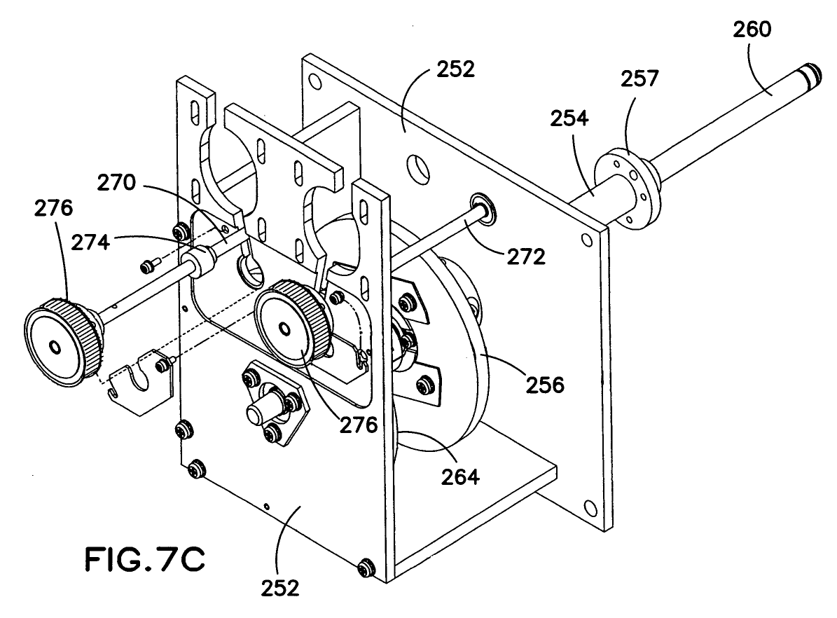

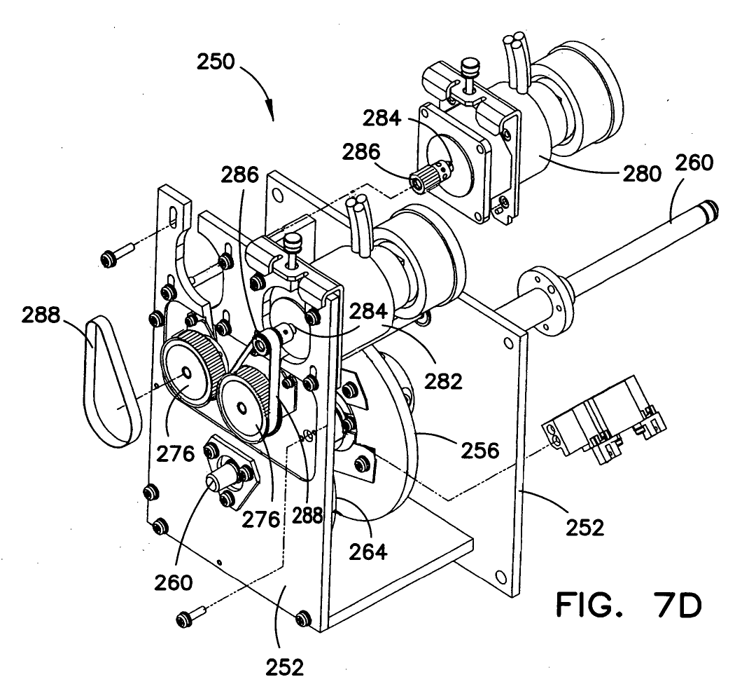

The reagent station 16 comprises a storage rack operable to retain the plurality of reagent cartridges 40. In the embodiment shown in FIGS. 1-3, the reagent station 16 comprises first storage rack in the form of a first circular carousel 200 and a second storage rack in the form of a second circular carousel 202 (see FIG. 6D). The first carousel 200 and second carousel 202 are substantially identical in design and are operable to receive and carry the plurality of reagent cartridges 40. The first carousel 200 is coaxial with the second carousel 202, with the first carousel serving as an upper carousel and the second carousel serving as the lower carousel, as shown in FIG. 6D, with the first carousel positioned above the second carousel. Both the first and second carousels 200 and 202 are independently rotatable about a center axis 204.

With reference to FIGS. 6A-6C, the first carousel 200 includes a central hub 210 which receives a rotatable first shaft 212 connected to a dual drive assembly (not shown in FIGS. 6A-6C). As explained in further detail below, the shaft 212 of the dual drive assembly may be rotated by means of a stepper motor under the control of the controller 178. The hub 210 supports a plurality of radial fingers 214 on the first carousel 200, which in turn define a plurality of slots 216 disposed radially about the hub 210. In the embodiment shown in FIG. 6A, thirty slots 216 are provided in the carousel. The side walls of each of the slots 216 expand slightly outwardly near the periphery of the first carousel 200 to define tapered openings 218. A peripheral reinforcing member 219 is formed about the edge of the carousel 200 to add rigidity to the carousel 200. The reinforcing member 219 is above the tapered openings 218 as seen in FIG. 6C to provide a clear path for insertion and removal of the reagent cartridges 40. Each of the slots 216 includes an internal shoulder 215. Depressions 217 are formed into the shoulder 215 proximate the periphery of the carousel 200. Reagent cartridges 40 are designed to be carried in the slots of the carousel. However, in the first carousel 200, one slot 205 is designated as an empty slot that will carry no reagent cartridge. This slot provides an opening 205 in the first carousel, and as explained in more detail below, forming a passage that allows a probe to reach though the first reagent carousel 200 and down to the second reagent carousel 202.

As mentioned above, the second carousel 202 is substantially identical to the first carousel 200. Accordingly, the second carousel 202 is not explained in additional detail herein.

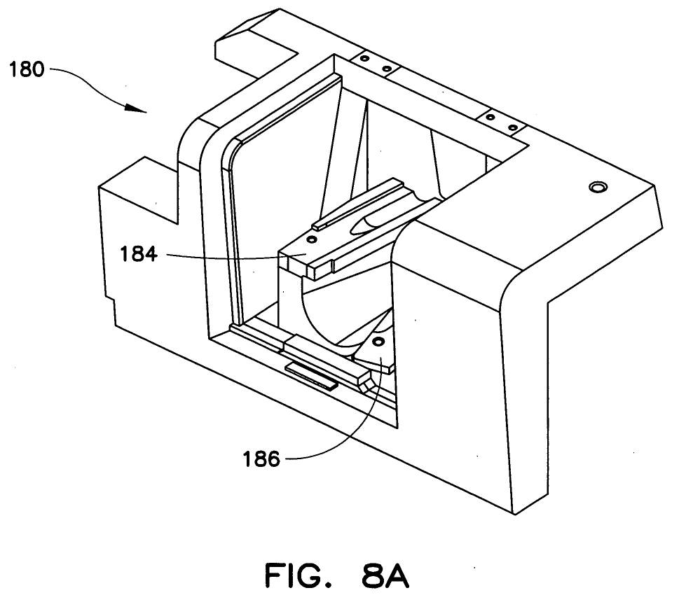

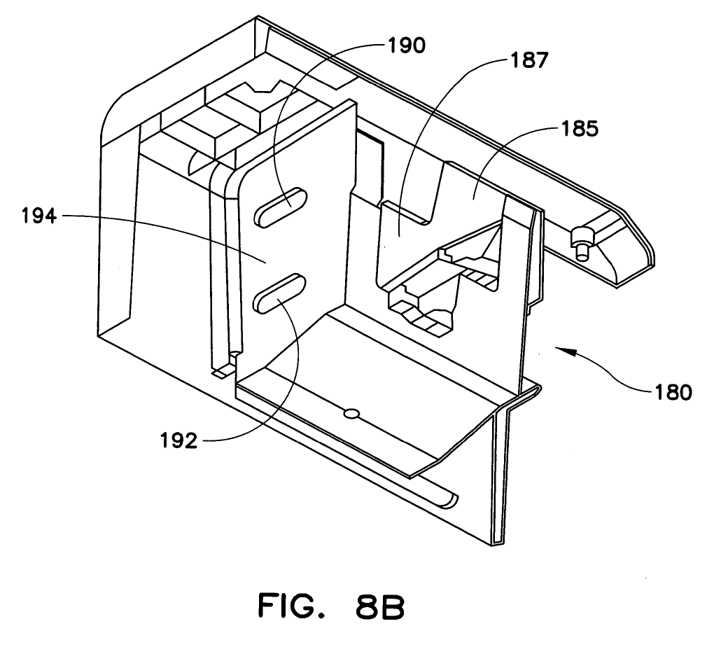

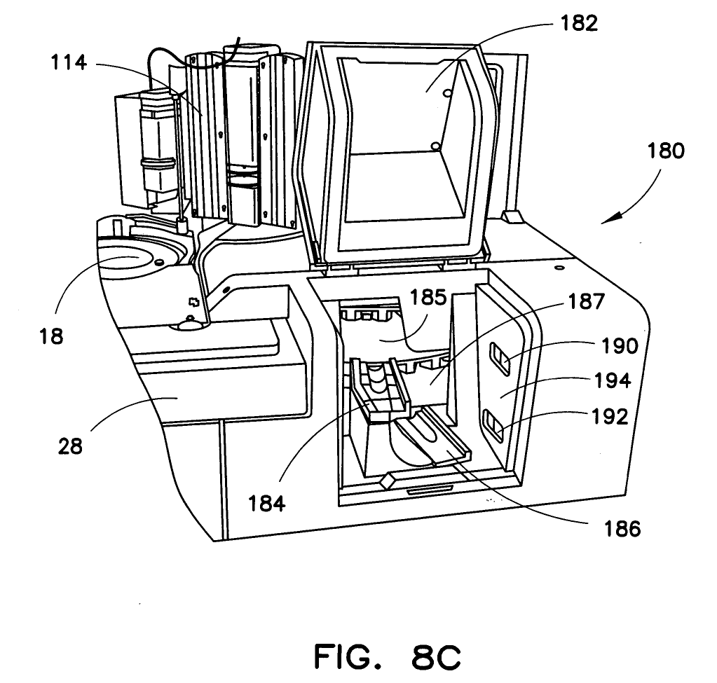

With reference to FIGS. 1, and 8A-8C, the cartridges are loaded onto the carousels 200 and 202 and into the refrigerated environment of the reagent station 16 through a cartridge loading station 180. The cartridge loading station 180 includes a station cover 182 (see FIGS. 2 and 3), an upper loading platform 184, and a lower loading platform 186. The upper loading platform 184 is designed and dimensioned to accept the footprint of a cartridge, orienting the cartridge for direct insertion through an upper loading door 185 and onto the upper reagent carousel 200. Likewise, the lower loading platform 186 is designed and dimensioned to accept the footprint of a cartridge, orienting the cartridge for direct insertion through a lower loading door 187 and onto the lower reagent carousel 202. The loading platforms 184 and 186 are aligned at a slight angle with respect to each other, since the cartridges are to be inserted directly on to the slots, and the upper and lower doors are slightly offset from one another.

As shown in FIGS. 8B and 8C, an upper bar code reader 190 and a lower bar code reader 192 are provided on the right sidewall 194 of the reagent cartridge loading station 180. These bar code readers 190 and 192 are operable to read bar-coded identification information printed on the right side of the reagent containers 40 before they are loaded onto the carousels 200 and 202. This identification information is then delivered to the controller 178, and stored in memory. Accordingly, the controller 178 is operable to record the location of all reagent cartridges 40 positioned in the slots 216 of the carousels 200 and 202, and deliver associated instructions to the stepper motors 280 and 282 during operation of the analyzer 10 in order to position the reagent cartridges in desired locations.

With reference to FIG. 4C and FIGS. 6A-6C after a reagent cartridge is fed through one of the doors 185 or 187, the cartridge 40 is received by one of the slots 216 of the carousels 200 or 202. The slots 216 on the upper carousel 200 are adapted to provide a first plurality of seats for the reagent cartridges and the slots 216 on the lower carousel 202 are adapted to provide a second plurality of seats for the reagent cartridges. In particular, the slots 216 in the carousels are adapted to receive the necks 155, 157 and 159 and the detent member 163 on the top of a reagent cartridge 40. The storage compartment 143 at the narrow end of the cartridge 40 is inserted first into one of the slots 216 and the annular collars 161 and the flanges 162 and 164 rest upon and are supported by the shoulder 215 in the slot 216. With the reagent cartridge 40 fully inserted into the slot 216, the teeth 165 of the detent member 163 come to rest in the depressions 217 near the periphery of the carousel 200. In this fashion, the cartridge 40 is retained on the carousel 200 and the carousel 200 may be rotated by the shaft 212 without displacing the cartridge 40 by centrifugal force. Furthermore, the combination of the shoulder 215 and the collars 161 along with the depressions 217 and teeth 165 serve to position the cartridge accurately on the carousel 200 for positive and repeatable access by a reagent probe 118, which is explained in further detail below.

To remove a cartridge 40 from the carousel 200, the storage compartment 147 of the cartridge is grasped and the cartridge 40 is raised slightly, disengaging the teeth 165 on the cartridge from the depressions 217 on the carousel 200, and enabling the cartridge 40 to be easily radially removed from the slot 216 within the carousel 200.

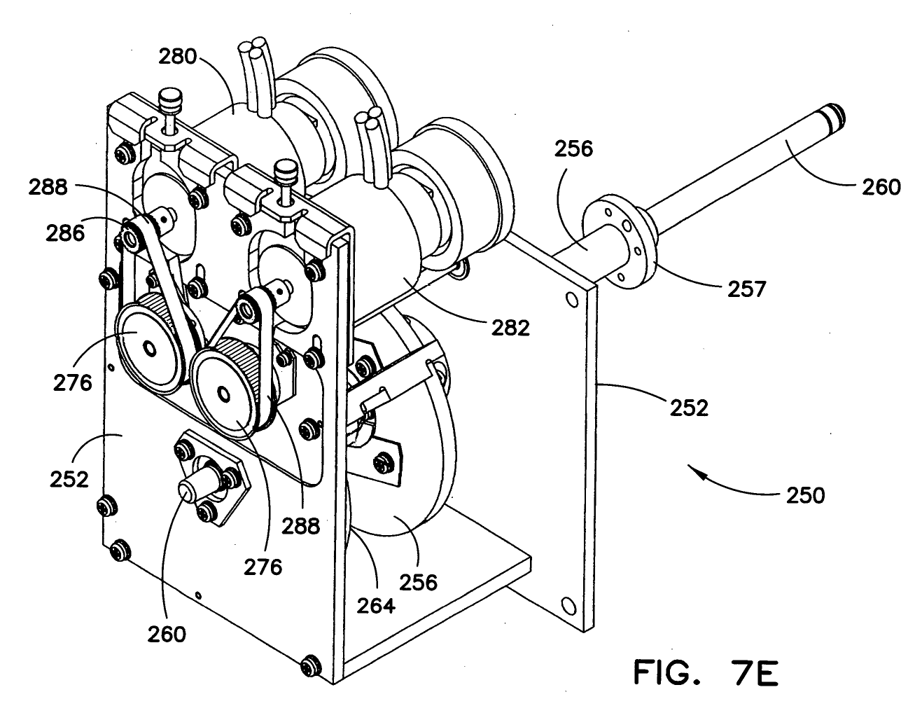

The first and second carousels 200 and 202 which hold the plurality of reagent cartridges are rotatably mounted in the automated clinical analyzer 10. Because the carousels 200 and 202 are rotatable, the slots of each carousel may be individually positioned in front of the loading doors 185 and 187 of the loading station 180 to facilitate loading and unloading of reagent cartridges. A dual carousel drive is provided in the analyzer 10 under the carousels for controllably rotating each of the carousels. A progressive assembly isometric of the dual carousel drive 250 is shown in FIGS. 7A-7E.

As shown in FIG. 7A the dual carousel drive 250 comprises a frame 252 that supports an outer shaft 254. The outer shaft 254 is hollow and is freely rotating upon the frame 252, supported on the frame by a bearing 258. The outer shaft includes an end ring 257 connected to a distal end of the outer shaft. The end ring 257 is used to connect the outer shaft to the hub of the lower carousel 202. An outer gear hub assembly 256 is fixed to a proximal end of the outer shaft 254 and rotates along with the outer shaft.

As shown in FIG. 7B, the dual carousel drive 250 further comprises an elongated inner shaft 260 that is longer than the outer shaft. The inner shaft 260 is inserted through the hollow outer shaft 254 such that a proximal end of the inner shaft extends through the outer shaft and is supported by a bearing 262 on the frame 252. A distal end of the inner shaft 260 extends past the end ring of the outer shaft 254. Thus, the inner shaft is partially retained within the outer shaft. The distal end of the inner shaft is designed for connection to the hub of the upper carousel 200. An inner gear hub assembly 264 is fixed to the proximal end of the inner shaft 260 near the bearing 262 and rotates along with the inner shaft 260, which inner shaft 262 is freely rotating with respect to the outer shaft 254.

With reference now to FIG. 7C, a first jackshaft 270 and a second jackshaft 272 are supported upon the frame 252. Each jackshaft 270 and 272 includes a ribbed wheel 276 connected to one end of the shaft. In addition, each jackshaft includes a gear 274 fixed to the jackshaft such that rotation of the jackshaft rotates the gear 274. The gear 274 of the first jackshaft 270 is operable to mesh with teeth on the outer gear hub assembly 256, thereby imparting rotation to the outer gear hub assembly 256 and connected outer shaft 254 when the first jackshaft 270 is rotated. The gear (not shown in FIG. 7) of the second jackshaft 272 is operable to mesh with teeth on the inner hear hub assembly 264, thereby imparting rotation to the inner gear hub assembly 264 and connected inner shaft 260 when the second jackshaft 272 is rotated.

As shown in FIGS. 7D and 7E, a first motor 280 and a second motor 282 are supported by the frame 252. The first motor 280 and second motor 282 both include a drive shaft 284 with a ribbed gear 286 on the end. A belt 288 extends around each ribbed gear 286 and each ribbed wheel 276, thereby forming a pulley system. When electric power is provided to the first motor 280, the ribbed gear 286 rotates, causing the ribbed wheel 276 to rotate. Rotation of the ribbed wheel 276 causes the gear 274 on the first jackshaft 270 to rotate, which, in turn, rotates the outer gear hub assembly 256 and connected outer shaft. Likewise, when electric power is provided to the second motor 282, the inner shaft 260 is rotated. The first motor 280 and second motor 282 are stepper motors operable to precisely rotate the upper and lower carousels 200 and 202 to desired rotated positions.

The dual carousel drive 250 is mounted below the upper carousel 200 and lower carousel 202 in the automated clinical analyzer 10. The inner shaft 260 is connected to the hub of the upper carousel 200 and the outer shaft 254 is connected to the hub of the lower carousel. Therefore, rotation of the inner shaft 260 imparts rotation to the upper carousel and rotation of the outer shaft 254 imparts rotation to the lower carousel. The controller 178 determines when power will be provided to the motors of the dual drive assembly, thereby controlling rotation of the upper and lower carousels 200 and 202 and positioning of the upper and lower carousels.

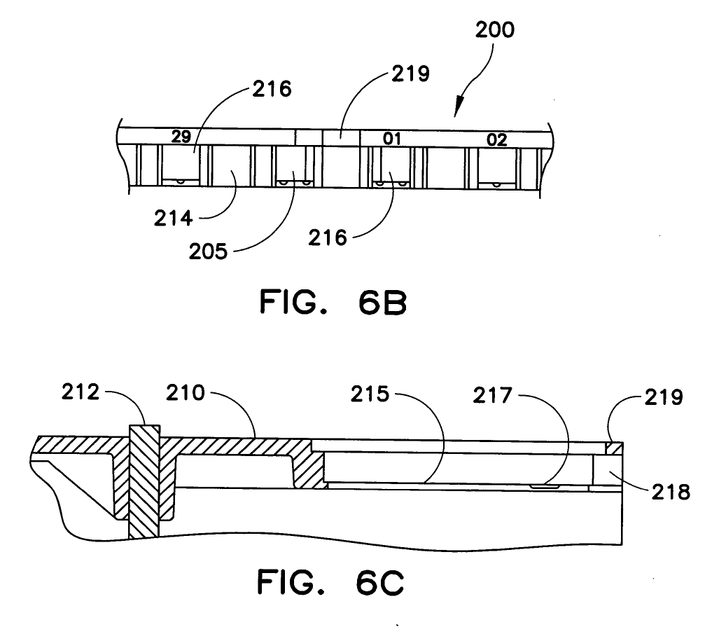

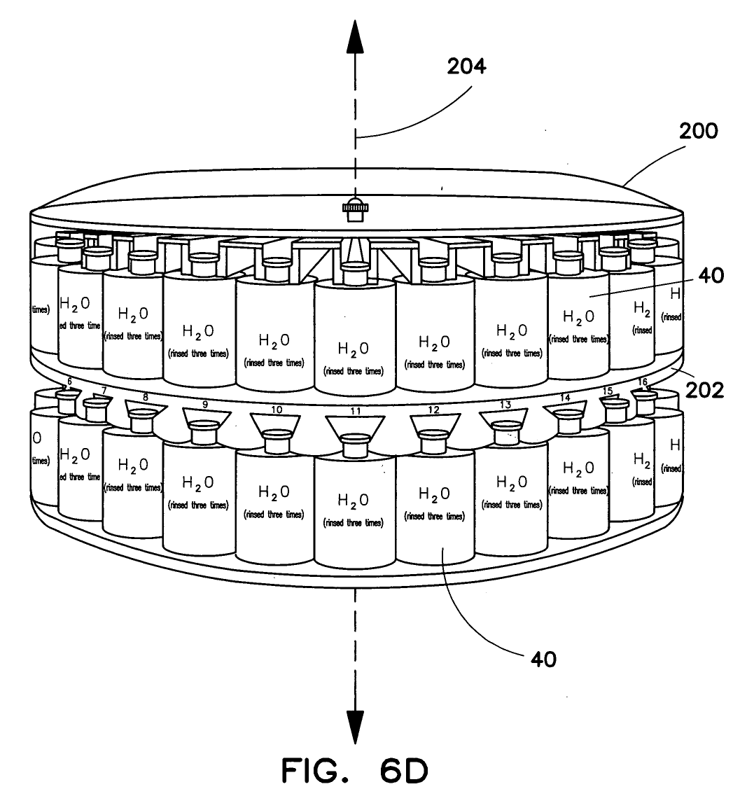

Controlled positioning of the carousels 200 and 202 by stepper motors 280 and 282 not only facilitates loading of the reagent cartridges 40 on to the carousels, but also facilitates proper positioning of the cartridges during operation of the analyzer 10 to allow access to the reagents at the reagent station 16. In particular, with reference to FIGS. 1 and 5B, the reagents contained within the cartridges 40 on the carousels 200 and 202 are accessed by a reagent probe 118 of a reagent probe arm assembly 114. The reagent probe arm assembly 114 is also referred to as an automated “crane” 114. The automated crane 114 is operable to position the probe 118 over a predetermined reagent extraction site 42. The reagent extraction site 42 generally defines the site above the reagent carousels 200 and 202 where the probe 118 is positioned in order to extract reagents from the reagent cartridges. To this end, the carousels are rotated such that reagent cartridges from which reagents are to be extracted are positioned directly below the reagent extraction site 42. The reagent extraction site 42 comprises three distinct extraction locations where the probe 118 may be located. Each of these three distinct extraction locations is vertically aligned with one of the three openings in the reagent cartridge properly positioned below the reagent extraction site.

The automated crane 114, as shown in FIG. 5B, generally comprises reagent probe arm 116 and a hollow reagent probe 118. The reagent probe 118 comprises an elongated tube having an internal chamber 120, an open lower end 122 defining a tip of the probe, and an open upper end 124. The reagent probe 118 is disposed generally vertically and is movable along with arm 116 by a reagent probe motor (not shown) between an upper reagent probe position and lower reagent probe positions. In the upper reagent probe position, the tip 122 of the probe is located above the carousels 200 and 202. In the lower reagent probe positions, the tip 122 of the probe is positioned to enter a cartridge positioned on one of the carousels 200 and 202 below the reagent extraction site 42. Thus, the reagent probe 118 must be long enough to extend past the upper carousel 200 and reach cartridges on the lower carousel 202. In addition, in the upper reagent probe position, the reagent probe arm 116 is horizontally movable by a reagent probe arm motor (not shown) between a first reagent probe arm position wherein the reagent probe 118 is immediately above the reagent extraction site 42 (see FIG. 1) and a second reagent probe arm position wherein the reagent probe is immediately above the cuvette reagent deposit site 52.

The reagent probe 118 is connected to a reagent probe pressure altering mechanism capable of alternatively applying a positive pressure and a negative pressure to the internal chamber 120 of the reagent probe 118. Such pressure altering mechanism can be any of the various pressure altering mechanisms known in the art. Typically, such pressure altering mechanisms are provided by a syringe pump 128, as shown in FIG. 5B. The reagent probe 118 is used to extract a predetermined quantity of reagent from a reagent cartridge 40 disposed within the reagent station 16 at the reagent extraction site 42 and transport that quantity of reagent to a cuvette 44 disposed within the random access analyzing station 18 at the cuvette reagent deposit site 52. In order to extract the predetermined quantity of reagent from the reagent container, the crane 114 is operable to move the probe vertically between the upper reagent probe position and the lower reagent probe positions.

When extracting reagents from the reagent cartridges on the upper reagent carousel 200, the upper reagent carousel is rotated such that the cartridge 40 containing the reagent to be extracted by the probe 118 is positioned below the reagent extraction site 42. The probe 118 is then moved from the upper reagent probe position down toward the cartridges 40 on the upper carousel 200 until the tip 122 of the probe passes through one of the openings 149, 151 or 153 and contacts the liquid reagent in the cartridge 40. Upon contacting liquid in the cartridge 40, a liquid level sense assembly 126 alerts the controller 178 that the tip of the probe has contacted liquid, and the probe is moved only a short additional distance such that the probe can extract the proper amount of liquid from the cartridge. After extracting the predetermined amount of liquid reagent, the probe 118 is moved back toward the upper reagent probe position, clear of both carousels 200 and 202, where the probe can be moved to another location for dispensing the liquid reagent. Of course, extraction of reagent from the reagent container 40 results in an adjustment of the liquid level within the container. When reagents from the container 40 have been completely extracted, the controller 178 is further operable to indicate that the container 40 should be replaced by a new cartridge.

When extracting reagents from the reagent cartridges on the lower reagent carousel 202, the upper carousel 200 must first be moved such that the opening 205 in the upper reagent carousel 200 is immediately below the reagent extraction site 42. This opening 205 allows the probe 118 to be moved from the upper reagent probe position, through the upper carousel 200, and down toward the lower reagent probe positions associated with the lower carousel 202. After the opening 205 in the upper carousel is positioned below the reagent extraction site, the lower reagent carousel 202 is rotated such that the cartridge 40 containing the reagent to be extracted by the probe 118 is positioned below the reagent extraction site 42. The probe 118 is then moved from the upper reagent probe position, through the opening 205 in the upper carousel 200, and down toward the lower carousel 200 until the tip 122 of the probe passes through one of the openings 149, 151 or 153 and contacts the liquid reagent in the cartridge 40. As discussed above, upon contacting liquid in the cartridge 40, a liquid level sense assembly alerts the controller 178 that the tip of the probe has contacted liquid. The probe is then moved only a short additional distance such that the probe can extract the proper amount of liquid from the cartridge.

After reagents are extracted and dispensed by the reagent probe 118, the reagent probe is cleaned using a probe tip cleaning assembly/collar 105, as shown in FIG. 5B. Such a probe tip cleaning collar is described in U.S. Pat. No. 5,408,891, the entirety of which is incorporated herein by this reference. The cleaning collar 105 includes a cleaning assembly chamber 107 connected in fluid tight communication with a source of cleaning liquid 109 and a disposal site 111. The cleaning collar 105 allows the probe 118 to be cleaned when the probe arm 116 is moving the probe 118 horizontally or when the probe 118 is docked in a cleaning position. The upper reagent probe position may generally serve as the cleaning position.

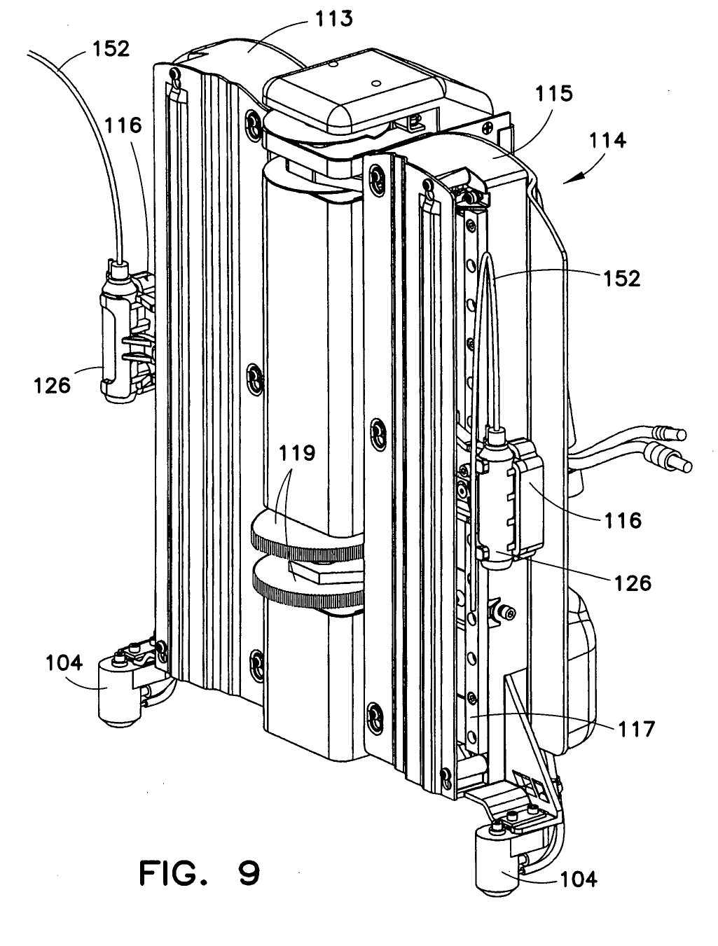

One embodiment of an exemplary crane assembly 114, not including the probe 118, is shown in FIG. 9. In this embodiment, two separate crane assemblies 113 and 115 are shown. For each crane assembly 113 and 115, the arm 116 is moved vertically along a track 117. Also, drive wheels 119 are operable to rotate each crane assembly 113 and 115, such that their respective tracks 117 are moved in the horizontal direction as they are rotated about an axis. This allows for a wide range of movement for each probe 118. Although neither probe is shown in FIG. 9, the probes are designed for attachment to crane at assembly 126, with the probe 118 extending down through the wash collar 104. Lines 152 connect the probe 118 to the syringe pump 128 (not shown in FIG. 9).

With reference now to FIGS. 1 and 4B, the random access analyzing station 18 of the automated clinical analyzer 10 is sized and dimensioned to retain a plurality of reaction cuvettes 44. In the embodiment shown in FIGS. 1-3, the random access analyzing station 18 is a revolving circular carousel capable of retaining in excess of 100 cuvettes 44. Each cuvette 44 is a small open top reaction container having at least two opposed transparent sides through which a beam of light can be directed. The random access analyzing station 18 further comprises random access analyzing station analyzer 46, such as a nephelometer and/or photometer disposed proximate to a random access analyzing station analyzing site 48 for determining at least one parameter of a sample disposed within the cuvettes 44. The random access analyzing station 18 is movable by a rotating motor (not shown) such that each cuvette 44 can be alternatively positioned under and moved away from at least one cuvette sample deposit site 50, at least one cuvette reagent deposit site 52, at least one cuvette mixing site 54, at least one cuvette washing site 56 and the one random access analyzing station analyzing site 48.

The reaction cup analyzing station 20 of the automated clinical analyzer 10 comprises at least one reaction cup module 58. Each reaction cup module 58 can be used to measure high volume analyses such as analyses for sodium, potassium, glucose, creatinine and blood urea nitrogen. In the embodiment shown in FIG. 1, the reaction cup analyzing station 20 comprises six reaction cup modules 58. Reagent is pumped to each reaction cup module 58 using reagent pump 59. The reaction cup modules 58 are drained to a suitable disposal site. A flow scheme for a reaction cup analyzing station is described in detail in U.S. Pat. No. 5,833,925, which is incorporated by reference in its entirety.

The ion selective electrode analyzing station 22 of the automated clinical analyzer 10 comprises a sample injection cup 60 disposed in fluid tight communication with a flow cell analyzer 62 is capable of measuring at least one electrolyte in a liquid sample. The ion selective electrode analyzing station 22 can be used to simultaneously analyze for sample electrolytes, such as sodium, potassium, calcium, chlorine and carbon dioxide. The sample injection cup 60 is disposed in fluid tight communication with an ion selective electrode analyzing station pump 64. The pump 64 is capable of pumping at least one ion selective electrode analyzing reagent from a source of such reagent (not shown) through the sample injection cup 60, through the flow cell analyzer 62 and then to a suitable waste disposal site. In the sample injection cup 60, the sample is mixed with reagent as the reagent is pumped through the sample injection cup 60 and into the flow cell analyzer 62. With this configuration of the ion selective analyzing station 22, reference solution, following each sample analysis, can be delivered into the flow cell analyzer 62. Measurement of the concentrations of sodium, potassium, calcium, chloride, and carbon dioxide in the reference solution can be performed to check electrode drifts, as will be recognized by those of skill in the art.

In the embodiment of the analyzing machine 10 shown in FIGS. 1-5, the analyzing machine 10 further comprises a sample container loading and preparation assembly 68. The loading and preparation assembly 68 comprises a loading mechanism 70 for loading one or more sample containers from a loading area 72 to the sample station 14 along a loading mechanism path 74. The loading mechanism 70 comprises an on-load tray 76 and an off-load tray 78. In the embodiment shown in FIG. 1, the on-load tray 76 and the off-load tray 78 are sized and dimensioned to retain a plurality of sample container racks 34. The on-load tray 76 has a motorized loading arm 80 for pushing a plurality of sample container racks 34 towards the loading mechanism path 74. The off-load tray 78 has a motorized unloading arm (not shown) for pushing the sample container racks 34 away from the loading mechanism path 74.

The loading mechanism path 74 has a motorized loading path arm 82 which moves a single sample container rack 34 along the loading mechanism path 74 on to and off from the sample station 14. A bar code reader 84 is typically disposed along the loading mechanism path 74. The bar code reader 84 is capable of reading bar coded information disposed on each individual sample container 32 as the sample container 32 moves along the loading mechanism path 74.

In the embodiment shown in FIG. 1, the sample container loading and preparation assembly 68 further comprises a sample container cap piercing mechanism 86 capable of piercing the sample container caps 36 so as to leave the caps 36 open for access by the sample extraction cup analysis probes (described below). As illustrated in FIGS. 2 and 3, the sample container cap piercing mechanism 86 can be disposed under a sample cap piercing mechanism cover 88.

The analyzing machine 10 further comprises a motorized sample probe arm assembly 90 such as shown in FIG. 5A. The sample probe arm assembly 90 is similar to the reagent probe arm assembly of FIG. 5B, discussed above. The sample probe arm assembly 90 includes a sample probe arm 92 and a hollow sample probe 94. The sample probe 94 has an internal chamber 96, an open lower end 98 and an open upper end 100. The sample probe 94 is disposed generally vertically in the sample probe arm 92 and is movable by a sample probe motor 102 between a lower sample probe position and an upper sample probe position. The sample probe 94 can be equipped with a sample probe tip cleaning assembly/collar 104 such as that described above with reference to the reagent probe 118.

Similar to the reagent probe 118, the sample probe arm 92 is movable by a sample probe arm motor (not shown) between a first sample probe arm position wherein the sample probe is immediately above the sample extraction site 38 and a second sample probe arm position wherein the sample probe is immediately above the cuvette sample deposit site 50. The sample probe 94 is connected to a sample probe pressure altering mechanism capable of alternatively applying a positive pressure and a negative pressure to the internal chamber 96 of the sample probe 94, such as a syringe pump 112. The sample probe arm assembly 90 is used to extract a predetermined quantity of sample from sample container 32 disposed within the sample station 14 at the sample extraction site 38 and transport that quantity of sample to a cuvette 44 disposed within the random access analyzing station 18 at the cuvette sample deposit site 50.

The analyzing machine 10 further comprises a cup analysis probe arm assembly 134 including a cup analysis probe arm and cup analysis probe. The cup analysis probe arm assembly 134 is used to extract a predetermined quantity of sample from a sample container 32 disposed within the sample station 14 and transport that quantity to each of the reaction cup modules 58 and to the sample injection cup 60. To this end, the cup analysis probe arm is movable between a first cup analysis probe arm position wherein a cup analysis probe is immediately above a sample container 32 in the sample station 14, a second cup analysis probe arm position wherein the cup analysis probe is immediately above one of the reaction cup modules 58, and a third cup analysis probe arm position wherein the cup analysis probe is immediately above the sample injection cup 60. The cup analysis probe assembly includes a cup analysis probe pressure altering mechanism capable of alternatively applying a positive pressure and a negative pressure to the cup analysis probe. Such pressure altering mechanism can be any of the various pressure altering mechanisms known in the art. Typically, such pressure altering mechanisms are provided by a syringe pump.

Each of the pressure altering mechanisms usable in the analyzing machine can further comprise an obstruction detector 176 comprising a pressure detector operatively installed within the operative pressure transmitting conduits to alert the operator and/or shut down the machine should an obstructive pressure drop be detected within the pressure altering mechanism.

The analyzing machine 10 further comprises a cuvette stirring rod assembly 156, which includes an elongate rotatable cuvette stirring rod. The cuvette stirring rod arm assembly 156 is positionable above the cuvette mixing site 54. In addition, the analyzing machine 10 comprises a cuvette wash station 166. The cuvette wash station is used to extract liquid reaction mixtures from the cuvettes 44, dispose such mixtures to a suitable disposal site and then rinse and clean the cuvette 44 so that it can be used to analyze another quantity of sample.

As discussed above, the automated analyzing machine 10 includes a controller 178. The controller is operable to control each of the various motors of the machine 10 in a way which provides for the smooth, efficient and rapid operation of the machine 10. The controller 178 is typically also used to retain and report analysis data. Preferably, the controller 178 comprises a digital computer which can be preprogrammed with a large variety of operating instructions depending upon the samples being analyzed, the analyses to be run and the reagents at hand. Most preferably, the digital computer receives bar coded information regarding each of the samples to be analyzed, and the reagents in the reagent station 16 and uses that information to most efficiently conduct the analyses. Also, it is preferable that the controller 178 keep track of the amounts of reagents used so as to alert the operator whenever reagent in any particular reagent container 40 begins to run low.

In operation, the operator of the automated analyzing machine of the invention 10 places samples to be analyzed in individual sample containers 32 and places each sample container 32 in one or more sample container racks 34. The sample container racks 34 are placed in the on-load tray 76.

The motorized loading arm 80 pushes sample container racks 34 in the on-load tray 76 towards the loading mechanism path 74. As each sample container rack 34 enters the loading mechanism path 74, the motorized loading path arm 82 pushes the sample container rack 34 along the loading mechanism path 74 towards the sample station 14.

As the sample containers 32 pass by the bar code reader 84, bar-coded information appended to each sample container 32 is read by the bar code reader 84 and is transmitted to the controller 178. Such bar code coded information typically includes the identity of the sample and the analyses which are to be run using individual portions of the sample.

As the sample container rack 34 is pushed further along the loading mechanism path 74, it passes under the cap piercing mechanism 86. The cap piercing mechanism 86 pierces the caps 36 on each of the sample containers 32. The sample container rack 34 then is loaded into the sample station 14 wherein a clamping mechanism within the sample station 14 holds the sample container rack 34 firmly upright.

The sample station 14 is rotated under the control of the controller 178. When an individual sample container 32 is placed at a sample extraction site 38, a small quantity of the sample is extracted from the sample container 32 by the sample probe 94. This is accomplished by positioning the sample probe 94 above the sample extraction site 38, lowering the sample probe 94 to the lower sample probe position wherein the open-ended lower end 98 of the sample probe 94 is placed below the surface of the sample within the sample container 32. A small quantity of the sample is then extracted into the sample probe internal chamber 96 by drawing a vacuum on the sample probe internal chamber 96 using the sample probe pressure altering mechanism. The sample probe 94 is then raised to the upper sample probe position and the sample probe arm 92 moves the sample probe 94 to a position where it is directly above the cuvette sample deposit site 50.

At the cuvette sample deposit site 50, the sample probe 94 is again lowered to the lower sample probe position and the quantity of sample within the sample probe 94 is deposited into a cuvette 44 positioned at the cuvette sample deposit site 50. This is done by creating a slight elevated pressure within the sample probe internal chamber 96 using the sample probe pressure altering mechanism. The lower end of the sample probe 94 is then retracted into the sample probe tip cleaning assembly 104 where it is rinsed using cleaning liquid from the source of cleaning liquid 108. After cleaning, the cleaning liquid is flushed to a suitable disposal site 110. The sample probe 94 is then ready to extract another quantity of sample from another sample container 32.

Contemporaneously with the above-described action of the sample probe 94, the reagent probe 118 is used in similar fashion to extract a quantity of an appropriate pre-mixed reagent from the reagent station 16 and deposit that quantity of reagent into the cuvette 44. Usually the reagent is added to the cuvette immediately prior to the deposit of the sample within the cuvette 44.

To extract a quantity of pre-mixed reagent, the controller 178 first identifies the appropriate slot where the cartridge containing the particular reagent is located. The carousel containing the reagent is then rotated by operation of the dual carousel drive system 250 until the slot holding the reagent cartridge is positioned under the reagent extraction site 42. If the cartridge containing the reagent is on the upper carousel 200, the reagent probe 118 is lowered into the cartridge 40 and reagent is extracted by the probe. If the cartridge containing the reagent is on the lower carousel 202, the upper carousel 200 is rotated to place the opening 205 in the upper carousel directly below the reagent extraction site. The probe is then lowered through the opening 205 in the upper carousel 200 and all the way down to the lower carousel where the probe is lowered into the cartridge and reagent is extracted by the probe. Once the reagent probe has extracted a volume of the desired reagent, the reagent probe is returned to the upper position and the reagent probe arm moves the reagent probe to the cuvette reagent deposit site 52 where the probe dispenses the reagent into the cuvette 44. After reagent is deposited into the cuvette at the reagent dispense position 52, the reaction station 18 is rotated to move the cuvette toward the sample dispense position 40. Approximately three minutes elapse between the time a cuvette receives reagent at the reagent dispense position 52 and the time the cuvette receives a sample at the sample dispense position, as other cuvettes are filled at the random access analyzing station 18 rotates.

After sample and reagent are both added to the cuvette 44, the cuvette 44 is rotated to the cuvette mixing site 54. At the cuvette mixing site 54, the cuvette stirring rod is lowered and the stirring rod is rotated so as to agitate and thoroughly mix the sample and reagent within the cuvette 44. In one embodiment, the mixer is moved to the dispense site 50 or 52 to mix the reagent or sample following introduction of liquid into the cuvette at the dispense site.

In typical random access analyzing operations wherein analyses are carried out at an elevated temperature, the mixture of sample and reagent within the cuvette 44 is then allowed to stand within the random access analyzing station 18 while the mixture is brought up to temperature, such as by blowing heated air through the random access analyzing station 18. In one embodiment, the cuvettes 44 in the random access analyzing station 18 are brought to and held at a carefully controlled temperature by thermal conductivity with the core of the station 18. When a mixture within the cuvette 44 has reached proper temperature, the contents of the cuvette 44 are analyzed using the random access analyzing station analyzer 46. After analyses are completed regarding the mixture within the cuvette 44, the cuvette 44 is moved to the cuvette washing site 56 at the cuvette wash station 166 where the cuvette 44 is rinsed once or several times using pressurized washing liquid. After the rinse liquid is removed from the cuvette 44 and sent to suitable disposal, the cuvette 44 is ready to accept another sample for analysis.

Contemporaneously with the operation of the random access analyzing station 18, high volume analyses may be are performed in the reaction cup analyzing station 20 and in the ion selective electrode analyzing station 22, as is known to those of skill in the art.

After the sample within each of the sample containers 32 in a sample container rack 34 are analyzed, the sample container rack 34 is removed from the sample station 14 using the motorized loading path arm 82. The sample container rack 34 is retracted along the loading mechanism path 74 to the off-load tray 78. Once in the off-load tray 78, the motorized unloading arm pushes the sample container rack 34 towards the end of the off-load tray 78 where it is removed by the operator.

While the dual carousel system described herein provides increased reagent storage space that makes operation of the automated clinical analyzer more efficient, unlimited storage space is, of course, not possible. Therefore, during operation of the automated clinical analyzer, different reagents than those available on the carousels 200 and 202 may be desired. In addition, reagents within individual cartridges will be completely extracted over time. In these situations, reagent cartridges may be easily loaded and unloaded at the reagent loading station 180. When loading reagent cartridges 40, each cartridge is first placed on the upper platform 184 or lower platform 186, depending upon whether the cartridge is to be placed in the upper carousel or lower carousel. When the cartridge is placed on the upper platform 184 or lower platform 186, the associated bar code reader 190 or 192 on the sidewall 194 of the reagent loading station 180 reads the bar code on the side of the cartridge. The bar code contains identification information for the reagent cartridge, and the identification information is associated with the slot where the cartridge is loaded. After the bar code reader indicates that the bar code was successfully read, the cartridge is simply pushed forward, through the upper door 185 or lower door 187 of the reagent loading station 180, and into the slot of the carousel positioned to receive the cartridge. Similarly, when a reagent cartridge is unloaded, the cartridge is pulled from the slot facing the door 185 or 187. As the cartridge exits the door, the bar code reader reads the bar code on the side of the cartridge, and the controller notes that the cartridges has been removed and the slot previously occupied by the cartridge on the carousel 200 or 202 is now open.

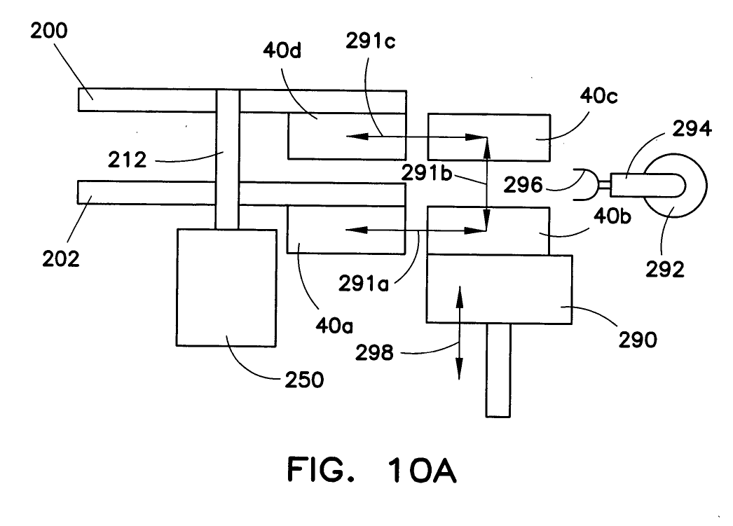

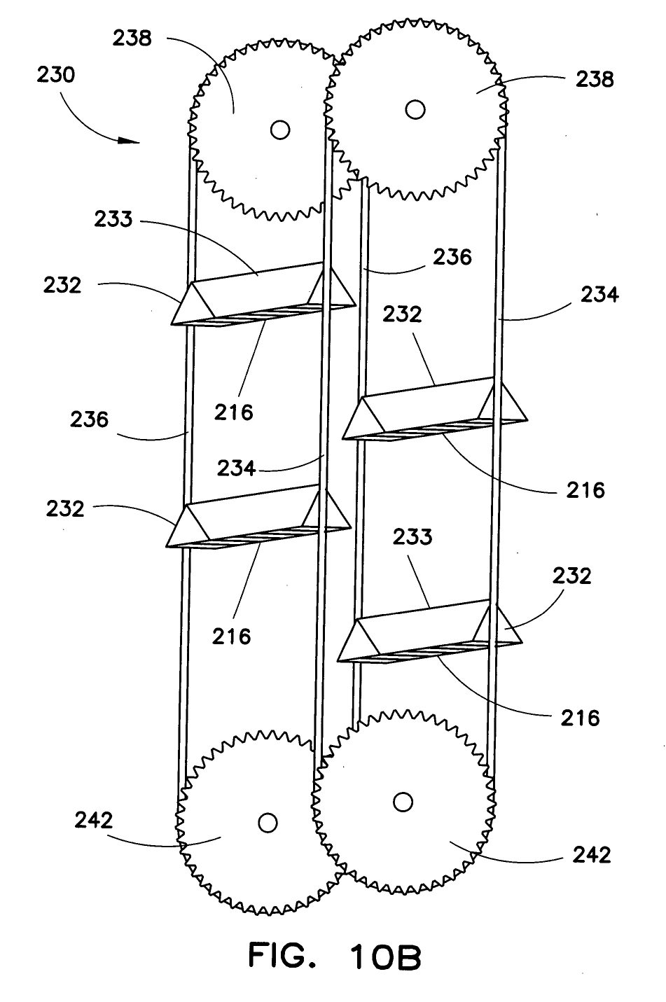

One alternative embodiment of the automated clinical analyzer is shown in FIG. 10A. In this embodiment, the reagent probe is not operable to extend all the way to the second carousel 202, but only extends to the upper carousel 200. In this embodiment, a cartridge lift in the form of a cartridge elevator 290 is provided that is operable to move up and down, as indicated by arrow 298. In particular, the elevator 290 is operable to move a cartridge 40 from the lower carousel 202 to the upper carousel 200 so that the cartridge may eventually be positioned under the reagent extraction site. A robotic pic and place device 292 is also provided in conjunction with the cartridge elevator 290. The pic and place device 292 includes a telescoping robotic arm 294 and a robotic hand. The robotic arm 294 may be moved into position to allow the robotic hand 296 grasp a reagent cartridge from either the upper reagent carousel 200 or the lower reagent carousel 202 and place it on the cartridge elevator, as shown by arrow 291a. In particular, when reagent is to be extracted from a cartridge on the lower carousel 202, the lower carousel is moved to a cartridge extraction site across from the elevator 290 in a lowered position. Then, the robotic arm 294 extends the robotic hand 296 toward the desired cartridge. The robotic hand 296 grasps the cartridge, pulling it from the seat of the lower carousel 202, indicated by position 40a in FIG. 10A. The pic and place device 292 then places the cartridge on the elevator 290 in position 40b, as indicated by arrow 291a. The elevator 290 is then moved upward, as indicated by arrow 291b, moving the cartridge from position 40b to position 40c. Next, the pic and place device moves the cartridge from the elevator 290 to an open seat on the upper carousel 200. This action is represented by arrow 291c in FIG. 10A, which shows the cartridge moving from position 40c to position 40d. Thereafter, the upper carousel is rotated to move the cartridge to the reagent extraction site. After reagent is extracted from the cartridge, the cartridge is returned to the lower carousel 202, using the robotic pic and place 292 and the elevator 290 to move the cartridge as shown by arrows 291c, 291b, and 291a in FIG. 10A.

FIG. 10B shows another alternative embodiment of a storage rack for the automated clinical analyzer. In this embodiment, the storage rack for the reagent cartridges comprises a reagent seat lift 230 including a plurality of cars 232. Each of the cars 232 includes a plurality of seats in the form of slots 216 for receiving reagent cartridges. Each of the cars is suspended on the lift by a support bar 233 that spans across two parallel drive chains 234 and 236. Each of the drive chains 234 and 236 form a loop. Top sprockets 238 and lower sprockets 242 engage opposite ends of each loop formed by the chains. Rotation of the top sprockets 238 and the lower sprockets 242 cause the chains to rotate within the loop. As the chains 234 and 236 move, the cars 232 suspended across the chains also move either upward or downward, depending upon the direction of rotation of the chains. In this fashion, each of the cars 232 may be moved to a reagent extraction position, such as a position near the top sprockets 240, where the reagent probe is operable to extract reagents from one or more of the cartridges seated in the car. Rotation of the chains for a full loop will result in cars exchanging positions in terms of their height relative to one another during the rotation. Also, although only four cars are shown in FIG. 10B, many more cars may be added to the lift 230.

Although the present invention has been described with respect to certain preferred embodiments, it will be appreciated by those of skill in the art that other implementations and adaptations are possible. For example, in alternative embodiments of the invention, the storage racks that hold the reagent cartridges may take on different forms, such as a storage rack that moves vertically up and down. Moreover, there are advantages to individual advancements described herein that may be obtained without incorporating other aspects described above. Therefore, the spirit and scope of the appended claims should not be limited to the description of the preferred embodiments contained herein.

What is claimed is:

1. A clinical analyzer operable to store reagent cartridges, the clinical analyzer comprising:
a) a body defining a horizontal operating orientation for the clinical analyzer;
b) a reagent storage rack arranged within the body, the reagent storage rack comprising a first plurality of reagent cartridge seats and a second plurality of reagent cartridge seats operable to receive the reagent cartridges, wherein the first plurality of reagent cartridge seats are positioned higher than the second plurality of reagent cartridge seats when the body is in the horizontal operating orientation; and
c) a reagent probe operable to extract reagents from reagent cartridges positioned in the first plurality of reagent cartridge seats.

2. The clinical analyzer of claim 1 wherein the reagent probe is further operable to extract reagents from reagent cartridges positioned in the second plurality of reagent cartridge seats.

3. The clinical analyzer of claim 2 wherein the reagent storage rack comprises an upper reagent carousel including the first plurality of reagent cartridge seats and a lower reagent carousel including the second plurality of reagent cartridge seats.

4. The clinical analyzer of claim 3 wherein the reagent probe is vertically moveable between the upper reagent carousel and the lower reagent carousel.

5. The clinical analyzer of claim 2 wherein the reagent storage rack comprises a reagent seat lift operable to elevate or lower the first plurality of reagent cartridge seats and the second plurality of reagent cartridge seats.

6. The clinical analyzer of claim 5 wherein the reagent seat lift is operable to elevate the second plurality of reagent cartridge seats above the first plurality of reagent cartridge seats.

7. The clinical analyzer of claim 2 further comprising a cartridge lift operable to move a lower reagent cartridge positioned on one of the second plurality of reagent cartridge seats to one of the first plurality of reagent cartridge seats.

8. The clinical analyzer of claim 7 wherein the cartridge lift comprises an elevator.

9. The clinical analyzer of claim 7 wherein the lift comprises a robotic arm.

10. The clinical analyzer of claim 7 wherein the reagent probe is only operable to extract reagent from the lower reagent cartridge positioned on one of the second plurality of reagent cartridge seats after the lower reagent cartridge has been moved to one of the first plurality of reagent cartridge seats.

11. The clinical analyzer of claim 1 wherein the reagent storage rack is moveable.

12. The clinical analyzer of claim 1 wherein the reagent probe is moveable between the first plurality of reagent cartridge seats and the second plurality of reagent cartridge seats.

13. The clinical analyzer of claim 1 further comprising an elevator operable to move reagent cartridges between the first plurality of seats and the second plurality of seats.

14. The clinical analyzer of claim 1 wherein the clinical analyzer further comprises a random access analyzing station arranged within the body, the random access analyzing station sized and dimensioned to retain a plurality of reaction cuvettes and the reagent probe operable to dispense reagents to the plurality of reaction cuvettes.

15. The clinical analyzer of claim 1 wherein the reagent probe is moveable on the clinical analyzer between a reagent extraction site located above the reagent storage rack and a cuvette reagent deposit site located above the random access analyzing station.

16. The clinical analyzer of claim 1 wherein the first plurality of reagent cartridge seats are positioned directly above the second plurality of reagent cartridge seats.

17. A clinical analyzer comprising:
a) an upper carousel operable to rotate about a central axis, the upper carousel including a first plurality of seats;
b) a lower carousel operable to rotate about the central axis, the lower carousel including a second plurality of seats; and
c) a probe including a probe tip, the probe tip operable to move between the upper carousel and the lower carousel.

18. The clinical analyzer of claim 17 wherein the upper carousel comprises an upper wheel and the lower carousel comprises a lower wheel.

19. The clinical analyzer of claim 17 wherein the upper carousel includes an opening and the probe extends through the opening when the probe tip is moved to the lower carousel.

20. The clinical analyzer of claim 17 wherein a first plurality of reagent cartridges are positioned in the first plurality of seats and a second plurality of reagent cartridges are positioned in the second plurality of seats.

21. The clinical analyzer of claim 20 wherein the probe is operable to extract reagents from the first plurality of reagent cartridges or second plurality of reagent cartridges and dispense the reagents in a plurality of reaction cuvettes.

22. The clinical analyzer of claim 17 further comprising a random access analyzing station sized and dimensioned to retain a plurality of reaction cuvettes.

23. The clinical analyzer of claim 22 wherein the probe is moveable on the clinical analyzer between a reagent extraction site located above the upper carousel and a cuvette reagent deposit site located above the random access analyzing station.

24. The clinical analyzer of claim 17 further comprising a carousel drive including a first shaft connected to the upper carousel and a second shaft connected to the lower carousel, wherein the second shaft is at least partially retained within the first shaft.

25. A clinical analyzer comprising:
a) a first carousel operable to rotate about a first axis, wherein a first plurality of cartridges are positioned on the first reagent carousel;
b) a second carousel operable to rotate about a second axis, wherein a second plurality of cartridges are positioned on the second reagent carousel; and
c) a probe operable to adjust liquid levels within the first plurality of cartridges and the second plurality of cartridges.

26. The clinical analyzer of claim 25 wherein the probe is operable to adjust liquid levels within the first plurality of cartridges and the second plurality of cartridges by extracting liquid reagents from the first plurality of cartridges at a reagent extraction site and extracting liquid reagents from the second plurality of cartridges at the reagent extraction site.

27. The clinical analyzer of claim 25 wherein the first carousel is an upper carousel and the second carousel is a lower carousel.

28. The clinical analyzer of claim 25 wherein the first axis and second axis are coaxial.

29. The clinical analyzer of claim 25 wherein the probe includes a probe tip and the probe is operable to move the probe tip between the first carousel and the second carousel.

30. The clinical analyzer of claim 29 wherein an opening is formed in the first carousel and the probe passes through the opening when the probe tip is moved to the second carousel.

31. The clinical analyzer of claim 25 further comprising a housing including a first loading door and a second loading door, wherein the first carousel and the second carousel are retained within the housing, and wherein the first loading door is designed and dimensioned to allow passage of each of the first plurality of cartridges, and the second loading door is designed and dimensioned to allow passage of each of the second plurality of cartridges.

32. The clinical analyzer of claim 25 wherein the first plurality and second plurality of cartridges comprise a plurality of liquid reagent cartridges.

33. The clinical analyzer of claim 32 wherein the probe is operable to extract liquid reagents from the first plurality of cartridges and dispense the extracted liquid reagents into a plurality of reaction cuvettes in a random access analyzing station.

34. The clinical analyzer of claim 25 wherein the reagent probe is moveable on the clinical analyzer between a reagent extraction site located above the first carousel and a cuvette reagent deposit site located above the random access analyzing station.

35. The clinical analyzer of claim 25 further comprising a carousel drive including a first shaft connected to the first carousel and a second shaft connected to the second carousel, wherein the second shaft is at least partially retained within the first shaft.

36. A clinical analyzer comprising:
a) a housing;
b) a first reagent carousel positioned within the housing and rotatable upon a first axis, the first reagent carousel including a first plurality of seats;
c) a second reagent carousel positioned within the housing and rotatable upon a second axis, the second reagent carousel including a second plurality of seats; and
d) an opening formed in the housing, the opening defining a first loading door and a second loading door, wherein the first loading door is designed and dimensioned to allow a reagent cartridge to pass through the first loading door and into one of the plurality of seats of the first reagent carousel, and wherein the second loading door is designed and dimensioned to allow a reagent cartridge to pass through the second loading door and into one of the plurality of seats of the second reagent carousel.

37. The clinical analyzer of claim 36 further comprising a bar code reader mounted on the housing, the bar code reader operable to read a bar code positioned on a reagent cartridge before it passes through the first loading door or the second loading door.

38. The clinical analyzer of claim 36 wherein the first axis and second axis are coaxial.

39. A clinical analyzer comprising:
a) an upper carousel operable to rotate about a first axis, the upper carousel including a passage and a first plurality of containers positioned on the upper carousel;
b) a lower carousel operable to rotate about a second axis, and a second plurality of containers positioned on the lower carousel; and
c) a probe including a probe tip operable to extend through the passage in the upper carousel such that the probe tip extends to the second plurality of containers.

40. The clinical analyzer of claim 39 wherein the probe is operable to extract a volume of reagent from the second plurality of containers.

41. The clinical analyzer of claim 40 wherein the probe is operable to extract a volume of reagent from the first plurality of containers.

42. The clinical analyzer of claim 39 wherein the probe is operable to dispense a volume of reagent.

43. The clinical analyzer of claim 39 wherein the probe is moveable on the clinical analyzer between a reagent extraction site and a cuvette deposit site.

44. The clinical analyzer of claim 39 further comprising a carousel drive including a first shaft connected to the upper reagent carousel and a second shaft connected to the lower reagent carousel, wherein the second shaft is at least partially retained within the first shaft.

45. The clinical analyzer of claim 39 wherein the probe is a reagent probe, the upper carousel is an upper reagent carousel, and the lower carousel is a lower reagent carousel.

46. A method of accessing reagents stored in reagent cartridges in a clinical analyzer, the method comprising:
a) loading a first plurality of reagent cartridges onto a first reagent storage rack;
b) loading a second plurality of reagent cartridges onto a second reagent storage rack;
c) moving a reagent probe to a reagent extraction site and extracting reagents from one of the first plurality of reagent cartridges;
d) moving the reagent probe away from the reagent extraction site; and
e) moving the reagent probe back to the reagent extraction site and extracting reagents from one of the second plurality of reagent cartridges.

47. The method of claim 46 wherein the first reagent storage rack is a first reagent carousel that includes a passage, and wherein the first reagent carousel is rotated such that the passage is positioned under the reagent extraction site before the reagent probe extracts reagents from the one of the second plurality of reagent cartridges.

48. The method of claim 47 wherein the second reagent storage rack is a second reagent carousel, and the second reagent carousel is rotated to place one of the second plurality of reagent cartridges under the reagent extraction site before extracting reagents from the one of the second plurality of reagent cartridges.

49. The method of claim 46 wherein the first reagent storage rack is rotated to place one of the first plurality of reagent cartridges under the reagent extraction site before extracting reagents from the first plurality of reagent cartridges.

50. The method of claim 46 wherein each of the first plurality and second plurality of reagent cartridges is substantially similar in size and shape and defines a reagent footprint, and wherein the area of the reagent extraction site is less than or equal to the area of the reagent footprint.

51. The method of claim 50 wherein each of the first plurality and second plurality of reagent cartridges includes three openings into the reagent cartridge, and wherein the reagent extraction site includes three distinct extraction locations for the reagent probe, each of the three distinct extraction locations vertically aligned with one of the three openings in the one of the first plurality of reagent cartridges under the reagent extraction site.

52. The method of claim 37 wherein the first reagent storage rack is positioned higher than the second reagent storage rack.
